(19) United States
(12) Patent Application Publication
(10) Pub. No.: US 2015/0050551 A1
(43) Pub. Date: Feb. 19, 2015

(54) NON-AQUEOUS LIQUID ELECTROLYTE FOR SECONDARY BATTERY AND SECONDARY BATTERY

(71) Applicant: FUJIFILM Corporation, Tokyo (JP)

(72) Inventor: Yohei ISHIJI, Ashigarakami-gun (JP)

(73) Assignee: FUJIFILM Corporation, Tokyo (JP)

(21) Appl. No.: 14/482,040

(22) Filed: Sep. 10, 2014

Related U.S. Application Data
(63) Continuation of application No. PCT/JP2013/057036, filed on Mar. 13, 2013.

(30) Foreign Application Priority Data
Mar. 15, 2012 (JP) 2012-058346

(51) Int. Cl. H01M 10/0567; H01M 10/052

(52) U.S. Cl. CPC H01M 10/0567; H01M 10/052; H01M 2300/0025
USPC 429/188

(57) ABSTRACT

A non-aqueous liquid electrolyte for a secondary battery, containing: an electrolyte; a polymerizable monomer; and a polymerization initiator in an organic solvent, in which the polymerization initiator has an element of Group XIII of the Periodic Table as a central element thereof and contains a compound capable of producing a radical and a Lewis acid in the liquid.

### CROSS-REFERENCE TO RELATED APPLICATIONS

This application is a Continuation of PCT International Application No. PCT/JP2013/057036 filed on Mar. 13, 2013, which claims priority under 35 U.S.C. §119 (a) to Japanese Patent Application No. 2012-058346 filed on Mar. 15, 2012. Each of the above applications is hereby expressly incorporated by reference, in its entirety, into the present application.

### TECHNICAL FIELD

The present invention relates to a non-aqueous liquid electrolyte for a secondary battery containing an organic solvent, and a secondary battery using the same.

### BACKGROUND ART

Secondary batteries called lithium ion batteries, currently attracting attention. They can broadly be classified into two categories of so called lithium ION secondary batteries and lithium METAL secondary batteries. The lithium METAL secondary batteries utilize precipitation and dissolution of lithium for the operation. Besides, the lithium ION secondary batteries utilize storage and release of lithium in the charge-discharge reaction. These batteries both can realize charge-discharge at large energy densities as compared with lead batteries or nickel-cadmium batteries. By making use of this characteristic, in recent years, these batteries have been widely applied to portable electronic equipment such as camera-integrated VTR's (video tape recorders), mobile telephones, and notebook computers. In accordance with a further expansion of applications, the development of lightweight secondary batteries such as to allow higher energy densities has been advanced as a power source of the portable electronic equipment. Furthermore, there is a strong demand for size reduction, service life prolongation, and safety enhancement.

Regarding a liquid electrolyte for lithium ion secondary batteries or lithium metal secondary batteries (hereinafter, these may be collectively referred to simply as a lithium ion secondary battery), in order to realize high electric conductivity and potential stability, a particular combination of materials has widely been employed. That is, a carbonic acid ester-based solvent such as propylene carbonate or diethyl carbonate is employed, in combination with an electrolyte salt such as lithium hexafluorophosphate.

With respect to the composition of a liquid electrolyte, a technique for making various kinds of additives to be contained in a liquid electrolyte is proposed for the purpose of improving cycle characteristics and the like. For example, in Patent Literatures 1 and 2, it is proposed that in order to restrain charge and discharge cycling characteristics from deteriorating for the reason that carbonate used as a liquid electrolyte is decomposed in a negative electrode, carbonate having a double bond such as vinylene carbonate (hereinafter abbreviated as VC) and vinylethylene carbonate (hereinafter abbreviated as VEC) is added to a liquid electrolyte, and VC, VEC and the like are electropolymerized on a negative electrode to form an oxidative polymerized film (hereinafter abbreviated as SEI) as a negative electrode protective film. Besides, a negative electrode protective film improves charge and discharge cycling characteristics, so that the formation of such a protective film in a positive electrode is performed in Patent Literatures 3, 4 and 5. Even though the structure of SEI is not clear, charge and discharge cycling characteristics are successfully improved.

### CITATION LIST

### Patent Literatures

Patent Literature 1: JP-A-2003-151621 (“JP-A” means unexamined published Japanese patent application)
Patent Literature 2: JP-A-2003-031259
Patent Literature 3: Japanese Patent No. 3787923
Patent Literature 4: JP-T-2008-538448
Patent Literature 5: Korean Patent No. 0419864

### SUMMARY OF THE INVENTION

### Technical Problem

However, the larger capacity is further demanded for the lithium ion battery, and hence the technical development has been progressed toward the increase in charging potential of the positive electrode. In this regard, SEI formed on a positive electrode suffers from large energy due to its high electric potential, and consequently SEI tends to be decomposed with bond cleavage. Thus, as it is assumed, it is difficult for SEI to maintain the state stably adhered on the positive electrode. It is thus unclear whether the additive revealed in the above-mentioned prior art may bring about a sufficient effect.

The present invention has been made in view of the situation as described above. The present invention thus addresses to the provision of a non-aqueous liquid electrolyte and a secondary battery using the same excellent in initial capacity and cycling characteristics.

### Solution to Problem

The inventors were in pursuit of the above technical subject, and they eventually found out that the combination of a polymerizable monomer and a specific polymerization initiator as a second additive allows cycling characteristics of a battery to be remarkably improved. Including presumption, the reason therefor may be conceived to be that a radical or a Lewis acid with high polymerization activity can be produced from the polymerization initiator by electrochemical oxidation in accordance with charge and discharge of a battery. That is to say, the polymerizable monomer may be subjected to radical polymerization by the oxidate or polymerization reaction through a catalytic action by a Lewis acid, and thereby made favorably into high molecular weight. Thus, even in the case where partial bond cleavage of the product is caused in a high-potential charging state, the maintenance of a state of stably attaching on a positive electrode may be conceived to be one factor of bringing the above-mentioned effect.

Further, a compound for capable of producing a polymerization active species and the polymerizable monomer are regarded as different components. Thus, it can be observed that the electron deficiency polymerizable monomer with high oxidation resistance may be efficiently polymerized, and a high-molecular weight body resistant to oxidation may be attached on a positive electrode. As a result, it may be conceived that even a small amount of addition can improve charge and discharge cycling characteristics.

The above-described problems of the present invention were solved by the following means.
{1} A non-aqueous liquid electrolyte for a secondary battery, containing:

an electrolyte,

a polymerizable monomer,

a polymerization initiator, and

an organic solvent;

the polymerization initiator having a central element, the central element being an element of Group XIII of the Periodic Table, the polymerization initiator being defined in a compound capable of producing a radical and a Lewis acid in a liquid.
{2} The non-aqueous liquid electrolyte for a secondary battery described in item {1}, wherein the polymerization initiator is a polymerization initiator represented by the following formula (I) or (II):

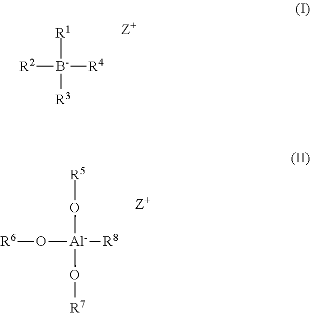

wherein R¹ to R³ each represent an aryl group or a heteroarylgroup; R⁴ represents an alkyl group, an aryl group, or a heteroarylgroup; Z⁺ represents a cation; R⁵ to R⁷ each represent an aryl group or a heteroarylgroup; and R⁸ represents an alkyl group.
{3} The non-aqueous liquid electrolyte for a secondary battery described in item {2}, wherein R⁴ in formula (I) is an alkyl group having 1 to 8 carbon atoms.
{4} The non-aqueous liquid electrolyte for a secondary battery described in any one of items {1} to {3}, wherein the polymerization initiator is a polymerization initiator represented by the following formula (III) or (IV):

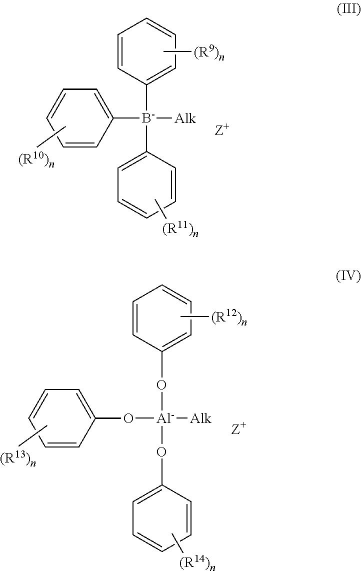

wherein R⁹ to R¹⁴ each represent an alkyl group, a fluoroalkyl group, an alkoxy group, a thioalkoxy group, a cyano group, a halogen atom, or an acyl group; n represents an integer of 0 to 5; Alk represents an alkyl group; and Z⁺ represents a cation.
{5} The non-aqueous liquid electrolyte for a secondary battery described in any one of items {1} to {4}, wherein the polymerizable monomer is a compound having a radical polymerizable site.
{6} The non-aqueous liquid electrolyte for a secondary battery as described in any one of items {1} to{4}, wherein the polymerizable monomer is a compound having a polymerizable site such that a reaction is accelerated by a Lewis acid.
{7} The non-aqueous liquid electrolyte for a secondary battery as described in any one of items {1} to {4}, wherein the polymerizable monomer is a compound having both a radical polymerizable site and a polymerizable site such that a reaction is accelerated by a Lewis acid.
{8} The non-aqueous liquid electrolyte for a secondary battery as described in {6} or {7}, wherein the polymerizable site such that a reaction is accelerated by a Lewis acid is a cycloalkyl group, an epoxy group, an oxetane group, a vinyl group, an isocyanate group, an alkoxysilyl group, a hydrosilyl group, or a transition metal alkoxide structure.
{9} The non-aqueous liquid electrolyte for a secondary battery as described in any one of items {1} to {8}, containing 5.0×10⁻¹ mol/L to 1.0×10⁻² mol/L of the polymerizable monomer.
{10} The non-aqueous liquid electrolyte for a secondary battery as described in any one of items (1) to (8), containing 5.0×10⁻² mol/L to 1.0×10⁻⁴ mol/L of the polymerization initiator.
{11} A secondary battery, containing the non-aqueous liquid electrolyte for a secondary battery described in any one of items {1} to {10}.
{12} A kit of a non-aqueous liquid electrolyte for a secondary battery, containing a mixture of a first agent and a second agent,

wherein the first agent contains an electrolyte, the second agent contains a polymerizable monomer, and a polymerization initiator containing a compound having an element of Group XIII of the Periodic Table as a central element thereof and being capable of producing a radical and a Lewis acid in the liquid is contained in the first agent, the second agent and/or another third agent.

In the present specification, in the chemical formula, when there are a number of substituents or linking groups (hereinafter, referred to as substituents and the like) that are indicated with specific symbols, or when plural substituents and the like are defined simultaneously or alternatively, the respective substituents and the like maybe identical with or different from each other. This also similarly applies to the definition of the number of substituents and the like. When the number of substituents and the like is defined as two or more, two or more of the substituents and the like may be different from or identical with each other. Further, unless particularly stated otherwise, when plural substituents and the like are contiguous to each other, they may be connected to each other or condensed to form a ring.

### Effects of the Invention

The non-aqueous liquid electrolyte of the present invention is excellent, in the application of a secondary battery, in ‘initial capacity’ exhibiting discharge performance at the initial stage of use and ‘cycling characteristics’ exhibiting resistance to deterioration in use. The non-aqueous liquid electrolyte of the present invention may develop the above-mentioned effect even though the added amount of a functional additive is small, and may cause to improve both cost and performance.

Other and further features and advantages of the invention will appear more fully from the following description, appropriately referring to the accompanying drawings.

### BRIEF DESCRIPTION OF THE DRAWINGS

FIG. 1 is a cross-sectional diagram illustrating a mechanism of a lithium ion secondary battery according to a preferable embodiment of the present invention, by modeling.

FIG. 2 is a cyclic voltammogram of a reference example.

FIG. 3 is a cyclic voltammogram of a reference example.

### MODE FOR CARRYING OUT THE INVENTION

Hereinafter, an embodiment of the present invention is described. However, the present invention is not construed by being limited thereto.

The non-aqueous liquid electrolyte for a secondary battery of the present invention contains a polymerizable monomer and a specific polymerization initiator. Hereinafter, a preferable embodiment thereof is described.

### [First Additive: Polymerizable Monomer]

The liquid electrolyte of the present invention contains a polymerizable monomer as a first additive.

Examples of the polymerizable monomer include a compound having a radical polymerizable group, a polymerizable site such that a reaction is accelerated by a Lewis acid, or both of them. It is desirable that a polymerizable compound suitable for the present invention has a basic structure which is not subject to oxidative decomposition in a positive electrode. Specifically, preferably a polymerizable monomer with an oxidation potential of 3.5 V to 5.5 V (in conversion against lithium) on a positive electrode. Further, the oxidation potential is more preferably 3.8 V to 5.0 V, furthermore preferably 4.0 V or more. The polymerizable compound is not particularly limited as long as it preferably satisfies the above-mentioned electric potential.

A specific measuring method and result of the oxidation potential are described later in examples. Typically, in voltammogram when the electric potential of the above-mentioned range is swept, whether oxidized or not may be evaluated by whether a current peak of 0.1 mA/cm² or more in absolute value is shown or not. This peak may be a broad one or the one having a shoulder, and may be evaluated and determined in the scope of producing the effect of the present invention. Alternatively, the peak may be evaluated while subtracting a base line of a chart.

Preferable examples of the polymerizable compound of the present invention include (meth)acrylate, (meth)acrylic acid amide, (meth)acrylic acid imide, unsaturated carbonate, unsaturated lactone or aromatic vinyl group (styryl group). These radical polymerizable parts react with a radical species produced when an initiator compound is electrolyzed to allow a high-molecular weight body, which is attached and accumulated on a positive electrode.

The radical polymerizable compound and an anionic polymerizable compound preferably include a compound having a carbon-carbon multiple bond. Examples of the compound having a carbon-carbon multiple bond include a vinyl compound, a styrene derivative, a (meth)acrylate derivative, and a cyclic olefin (optionally containing a hetero atom in a ring). A compound having a carbon-carbon multiple bond and a polar functional group is more preferable. Examples of the polar functional group include an ester group, a carbonate group, a nitrile group, an amide group, an urea group, a sulfolane group, a sulfoxide group, a sulfone group, a sulfonate, a cyclic ether group and a polyalkylene oxide group. These polar groups may form a chain structure or a ring structure.

Examples of the cationic polymerizable compound include an epoxy compound, an oxetane compound; and a vinyl ether compound.

Among them, a compound with a structure represented by any of the following formulae (3-a) to (3-d) is used particularly preferably as a radical polymerizable compound.

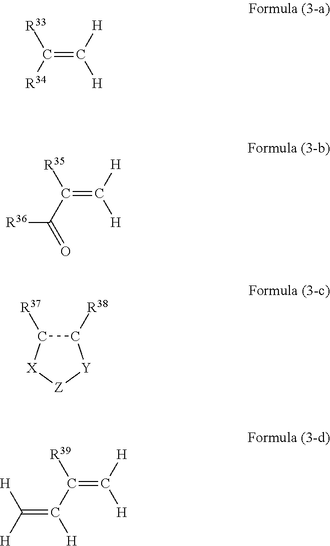

The dotted line of the formula (3-c) signifies a single bond or a double bond.
R³³

R³³ of the formula (3-a) represents a hydrogen atom or an alkyl group. The alkyl group preferable as R³³ is an alkyl group having 1 to 10 carbon atoms (such as methyl, ethyl, hexyl and cyclohexyl), and R³³ is more preferably a hydrogen atom.
R³⁴

R³⁴ of the formula (3-a) represents an aromatic group, a heterocyclic group, a cyano group, an alkoxy group or an acyloxy group. The aromatic group of R³⁴ is preferably a 27r aromatic group having 6 to 10 carbon atoms (such as phenyl and naphtyl), the heterocyclic group is preferably a heteroaromatic group having 4 to 9 carbon atoms (such as furyl, pyridyl, pyrazyl, pyrimidyl and quinolyl), the alkoxy group is preferably an alkoxy group having 1 to 10 carbon atoms (such as methoxy, ethoxy and butoxy), the acyloxy group is preferably an acyloxy group having 1 to 10 carbon atoms (such as an acetyl group and a hexanoyloxy group), and R³⁴ of the formula (3-a) is more preferably a phenyl group.
R³⁵

R³⁵ of the formula (3-b) represents a hydrogen atom, an alkyl group or a cyano group; the alkyl group is preferably an alkyl group having 1 to 10 carbon atoms (such as methyl, ethyl, hexyl and cyclohexyl), more preferably a hydrogen atom or a methyl group.
R³⁶

R³⁶ of the formula (3-b) represents an alkyl group, an alkoxy group or an amino group, more preferably an alkoxy group, that is, the compound represented by formula (3-b) is acrylate or methacrylate. The alkoxy group corresponding to an alcohol portion of ester in this case is preferably an alkoxy group having 1 to 10 carbon atoms (such as methoxy, ethoxy and butoxy), more preferably a methoxy group or an ethoxy group.
R³⁷ and R³⁸

R³⁷ and R³⁸ of the formula (3-c) each represent a hydrogen atom, an alkyl group, or an aromatic group. It is preferable that R³⁷ and R³⁸ are hydrogen atoms, or R³⁷ is a hydrogen atom and R³⁸ is an aromatic group. The aromatic group in this case is more preferably an aromatic group having 6 to 10 carbon atoms (such as phenyl and naphtyl).
X, Y and Z

X, Y and Z of the formula (3-c) each represent a divalent linking group selected from —O—, —S—, —(C═O)—, —C(═S)—, —SO—, and —SO₂— which may form a 5- or 6-membered ring; preferably, X and Y are —O— and Z is —(C═O)—. The above-mentioned R represents an alkyl group or an aromatic group. A preferable alkyl group signifies the same as that of R³³ and a preferable aromatic group signifies the same as that of R³⁴.
R³⁹

In formula (3-d), R³⁹ represents a hydrogen atom or an alkyl group, preferably a hydrogen atom or an alkyl group having 1 to 10 carbon atoms (e.g., methyl, ethyl, hexyl, or cyclohexyl), and more preferably a hydrogen atom or a methyl group.

The substituent of the above-mentioned R³³ to R³⁹ may further contain other substituent T.

Examples of the substituent T include an alkyl group (preferably an alkyl group having 1 to 20 carbon atoms, e.g. methyl, ethyl, isopropyl, t-butyl, pentyl, heptyl, 1-ethylpentyl, benzyl, 2-ethoxyethyl, or 1-carboxymethyl), an alkenyl group (preferably an alkenyl group having 2 to 20 carbon atoms, e.g. vinyl, allyl, or oleyl), an alkynyl group (preferably an alkynyl group having 2 to 20 carbon atoms, e.g. ethynyl, butadiynyl, or phenylethynyl), a cycloalkyl group (preferably a cycloalkyl group having 3 to 20 carbon atoms, e.g. cyclopropyl, cyclopentyl, cyclohexyl, or 4-methylcyclohexyl), an aryl group (preferably an aryl group having 6 to 26 carbon atoms, e.g. phenyl, 1-naphthyl, 4-methoxyphenyl, 2-chlorophenyl, or 3-methylphenyl), a heterocyclic group (preferably a heterocyclic group having 2 to 20 carbon atoms, e.g. 2-pyridyl, 4-pyridyl, 2-imidazolyl, 2-benzimidazolyl, 2-thiazolyl, or 2-oxazolyl), an alkoxy group (preferably an alkoxy group having 1 to 20 carbon atoms, e.g. methoxy, ethoxy, isopropyloxy, or benzyloxy), an aryloxy group (preferably an aryloxy group having 6 to 26 carbon atoms, e.g. phenoxy, 1-naphthyloxy, 3-methylphenoxy, or 4-methoxyphenoxy), an alkoxycarbonyl group (preferably an alkoxycarbonyl group having 2 to 20 carbon atoms, e.g. ethoxycarbonyl, or 2-ethylhexyloxycarbonyl), an amino group (preferably an amino group having 0 to 20 carbon atoms, e.g. amino, N,N-dimethylamino, N,N-diethylamino, N-ethylamino, or anilino), a sulfonamide group (preferably a sulfonamide group having 0 to 20 carbon atoms, e.g. N,N-dimethylsulfonamide, or N-phenylsulfonamide), an acyloxy group (preferably an acyloxy group having 1 to 20 carbon atoms, e.g. acetyloxy, or benzoyloxy), a carbamoyl group (preferably a carbamoyl group having 1 to 20 carbon atoms, e.g. N,N-dimethylcarbamoyl, or N-phenylcarbamoyl), an acylamino group (preferably an acylamino group having 1 to 20 carbon atoms, e.g. acetylamino, or benzoylamino), a cyano group, a hydroxyl group and a halogen atom (e.g. a fluorine atom, a chlorine atom, a bromine atom, or an iodine atom). Among these, an alkyl group, an alkenyl group, an aryl group, a heterocyclic group, an alkoxy group, an aryloxy group, an alkoxycarbonyl group, an amino group, an acylamino group, a cyano group and a halogen atom are more preferable; and an alkyl group, an alkenyl group, a heterocyclic group, an alkoxy group, an alkoxycarbonyl group, an amino group, an acylamino group and a cyano group are particularly preferable.

When a compound, a substituent or the like contains an alkyl group, an alkenyl group or the like, these groups may be linear or branched, and may be substituted or unsubstituted. Furthermore, when the compound, substituent or the like contains an aryl group, a heterocyclic group or the like, they may be monocyclic or fused-cyclic, and may be substituted or unsubstituted.

It is noted that in the present specification, the representation of the compound is used in the sense that not only the compound itself, but also its salt, its complex and its ion are incorporated therein. Further, it is used in the sense that the compound includes a derivative thereof which is modified in a predetermined part in the range of achieving a desired effect. Further, in the present specification, a substituent or a linking group that is not specified by substitution or non-substitution means that the substituent may have an optional substituent. This is applied to the compound that is not specified by substitution or non-substitution. Preferable examples of the substituent include the substituent T described above.

The examples of the polymerizable compound are described below. However, the present invention is not construed by being limited thereto.

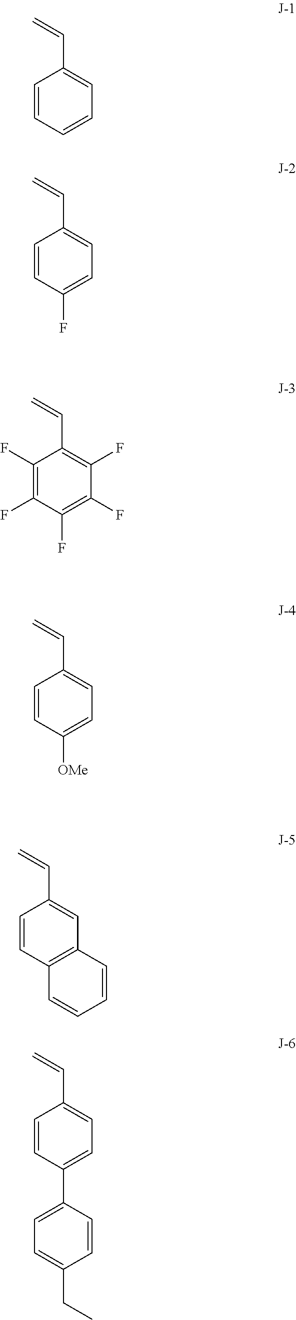

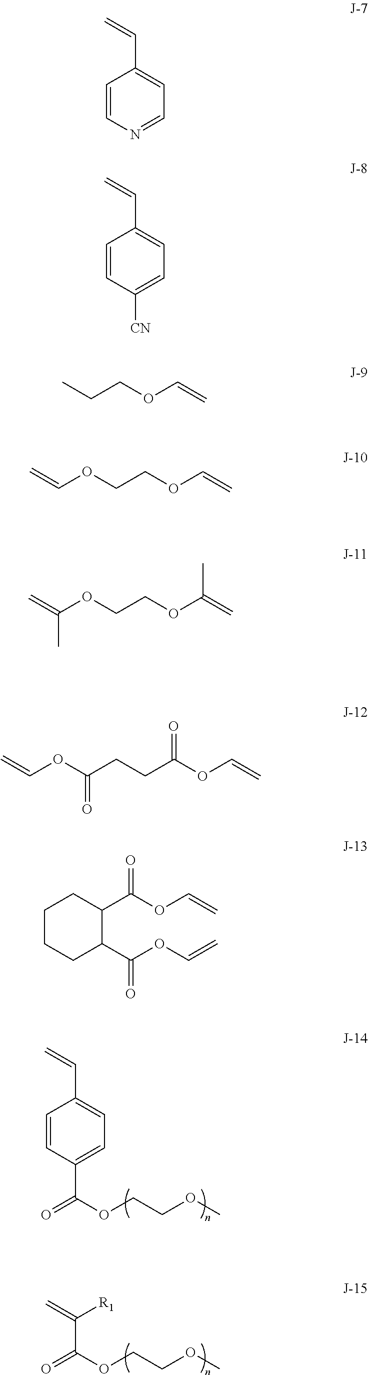

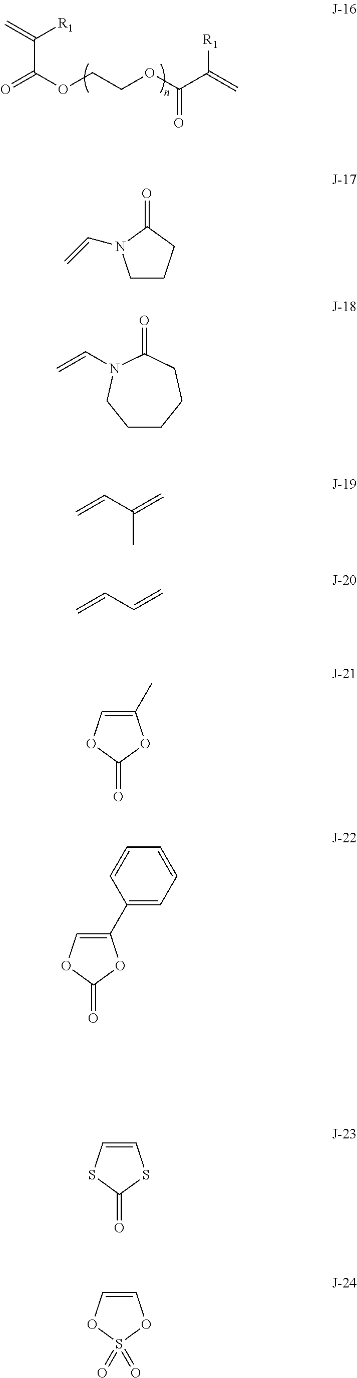

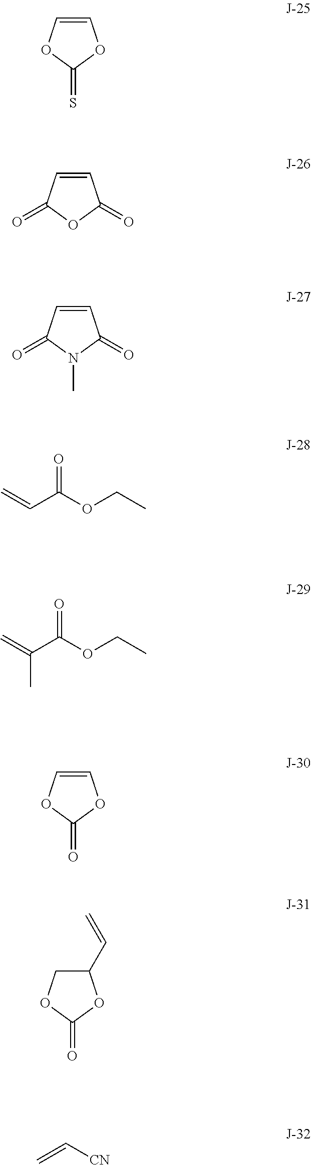

R₁ represents a hydrogen atom, an alkyl group, a halogen atom, or a cyano group.

n represents an integer of 1 to 20.

Examples of the polymerizable compound (the polymerizable site) such that a reaction is accelerated by a Lewis acid contained in the polymerizable compound in the present invention include a cycloalkane compound (a cycloalkyl group), an epoxy compound (an epoxy group), an oxetane compound (an oxetane group), a vinyl compound (a vinyl group), an isocyanate compound (an isocyanate group), an alkoxysilane compound (an alkoxysilyl group), a hydrosilane compound (a hydrosilyl group), and a transition metal alkoxide compound (a transition metal alkoxide structure). The transition metals of Group IV of the Periodic Table such as titanium, zirconium and hafnium are selected as a central metal of the transition metal alkoxide.

The functional group is more preferably a cycloalkane compound, a vinyl compound, an alkoxysilane compound and a transition metal alkoxide compound, furthermore preferably a cycloalkane compound, an alkoxysilane compound and a transition metal alkoxide compound. Titanium and zirconium are preferably as a central metal of the transition metal.

The compound having both a radical polymerizable site and a polymerizable site such that a reaction is accelerated by a Lewis acid is more preferably any structure of the following formulae (V) to (VII).

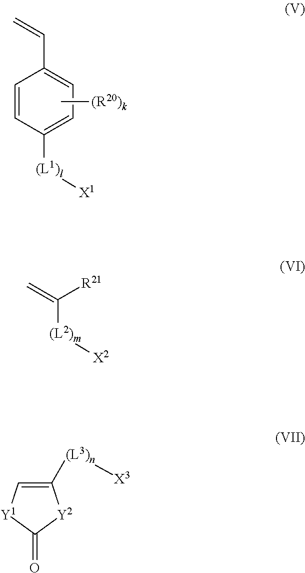

In formulae (V) to (VII), R²⁰ and R²¹ represent a hydrogen atom, an alkyl group, a fluoroalkyl group, an alkoxy group, a thioalkoxy group, a cyano group, a halogen and a carbonyl group. k, m, n and 1 represent an integer of 1 to 5. L¹ to L³ are a single bond or a linking group. The linking group is preferably an alkylene group, an alkylene oxide group, an alkoxycarbonyl group, an ether group, a thioether group and an amide group.

Y¹ and Y² represent any one of —O—, —CH₂— and —NH—. Besides, X¹ to X³ are a polymerizable site such that a reaction is accelerated by a Lewis acid. Examples thereof include a cycloalkyl group, an epoxy group, an oxetane group, a vinyl group, an isocyanate group, an alkoxysilyl group, a hydrosilyl group, or a transition metal alkoxide structure.

With regard to the added amount of a polymerizable monomer, in the case where the amount is too small, the effect of improving cycle characteristics is small; in the case where the amount is too large, internal resistance of a battery increases, so that initial characteristics of a battery is deteriorated. The concentration range thereof is preferably a range of 5.0×10⁻¹ mol/L to 1.0×10⁻² mol/L with respect to each liquid electrolyte. On the basis of mass, the concentration range is preferably 0.05% by mass or more, more preferably 0.1% by mass or more in the liquid electrolyte. The upper limit thereof is preferably 10 mass % or less, more preferably 5 mass % or less.

### [Second Additive: Polymerization Initiator]

A polymerization initiator as a second additive is a compound having an element of Group XIII of the Periodic Table as a central element thereof and being preferably capable of producing a radical and a Lewis acid. The polymerization initiator is preferably a compound which is oxidized at 3.5 V to 5.5 V (in conversion against lithium) in conversion against lithium potential and produces a radical and a Lewis acid, more preferably a compound which is oxidized at 3.8 V to 5.0 V. The central element is preferably boron or aluminum. When the central metal is boron, the boron and a substituent are preferably bonded by an atom other than a nitrogen atom thereof, more preferably substituted with a carbon atom.

A preferable structure among compounds composing the polymerization initiator is a structure represented by the following formula (I) or (II).

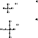

R¹ to R³ and le to R⁷

R¹ to R³ and R⁵ to R⁷ represent an aryl group (preferably having 6 to 14 carbon atoms, more preferably 6 to 9 carbon atoms, such as phenyl and trimethylphenyl), or a heteroaryl group (preferably having 1 to 12 carbon atoms, more preferably 3 to 7 carbon atoms, a hetero atom is nitrogen, oxygen and sulfur, such as pyridine, pyrimidine, triazine, thiazole and oxazole derivatives). In the formula (I), when the central metal is boron and R¹ to R³ are heteroaryl groups, the boron and heteroaryl groups are preferably bonded by an atom other than a nitrogen atom thereof, more preferably substituted with a carbon atom.
R⁴

R⁴ represents an alkyl group (preferably having 1 to 7 carbon atoms, such as methyl, ethyl, isopropyl, n-butyl and benzyl groups), an aryl group (preferably having 6 to 14 carbon atoms, more preferably 6 to 9 carbon atoms, such as phenyl, tolyl and anisoyl groups), or a heteroaryl group (preferably having 1 to 12 carbon atoms, more preferably 3 to 7 carbon atoms, a hetero atom is nitrogen, oxygen and sulfur, such as pyridine, pyrimidine, triazine, thiazole and oxazole derivatives). In the formula (I), when the central metal is boron and R¹ to R³ are heteroaryl groups, the boron and heteroaryl groups are preferably bonded by an atom other than a nitrogen atom thereof, more preferably substituted with a carbon atom.
R⁸

R⁸ represents an alkyl group (preferably an alkyl group having I to 7 carbon atoms, for example, methyl, ethyl, isopropyl, n-butyl and benzyl groups).

R¹ to R⁸ ma_{y} further have a substituent, and the substituent include the aforementioned substituent T.
Z⁺

Z⁺ represents a cation and examples of an organic cation include a tetraalkylammonium cation, an alkylimidazolyl cation, and the like. Alternatively, examples of an inorganic cation include lithium, sodium, potassium cations and the like.

The aforementioned formula (I) is preferably the following formula (I-1).

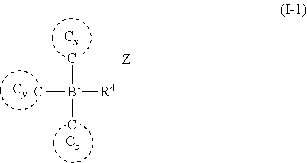

In formula (I-1), Cx, Cy, and Cz represent a group of atoms for forming an aryl group or a heteroaryl group with a carbon atom. The preferable examples of the aryl group or the heteroaryl group are the same as those of R¹ to R³.

The aforementioned polymerization initiator is further preferably a polymerization initiator represented by the following formula (III) or (IV).

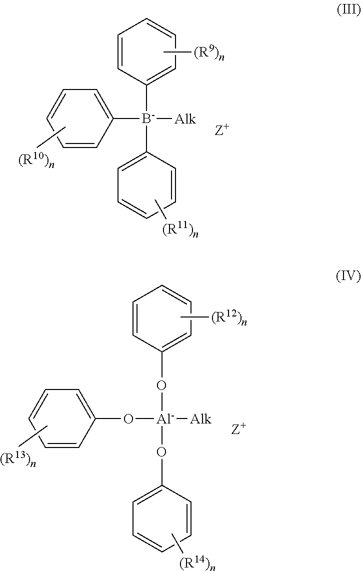

R⁹ to R¹⁴

R⁹ to R¹⁴ represent an alkyl group (preferably an alkyl group having 1 to 4 carbon atoms), a fluoroalkyl group (preferably a fluoroalkyl group having 1 to 4 carbon atoms), an alkoxy group (preferably an alkoxy group having 1 to 4 carbon atoms), a thioalkoxy group (preferably a thioalkoxy group having 1 to 4 carbon atoms), a cyano group, a halogen atom (preferably a fluorine atom), or an acyl group (preferably a acyl group having 1 to 6 carbon atoms).
n

n represents an integer of 0 to 5, preferably an integer of 1 to 5.
Alk

Alk represents an alkyl group (preferably an alkyl group having 1 to 7 carbon atoms) which may have a substituent. The substituent includes the aforementioned substituent T. Specific examples of the substituent preferably include a methyl group, an n-butyl group, and a benzyl group.

Z⁺ has the same meanings as those of formula (I).

With regard to the added amount of the second additive (polymerization initiator), in the case where the amount is small, the effect of polymerization initiation is small; in the case where the amount is too large, internal resistance of a battery increases, so that initial characteristics of a battery is deteriorated. The concentration range thereof is preferably a range of 5.0×10⁻² mol/L to 1.0×10⁻⁴ mol/L with respect to each liquid electrolyte. On the basis of mass, the concentration range is preferably 0.005% by mass or more, more preferably 0.01% by mass or more in the liquid electrolyte. The upper limit thereof is preferably 1 mass % or less, more preferably 0.1 mass % or less.

The examples of the polymerization initiator are described below. However, the present invention is not construed by being limited thereto.

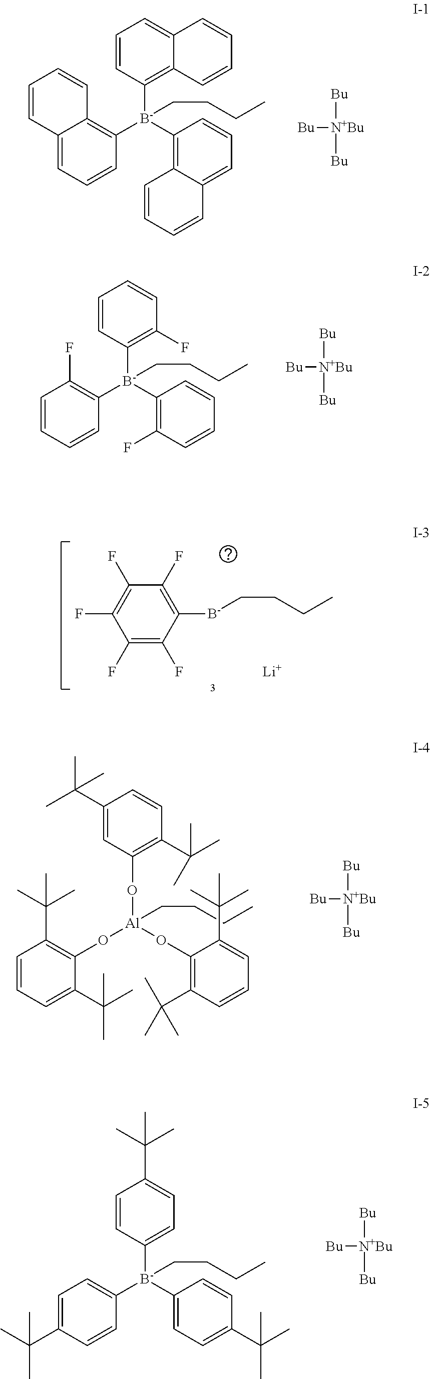

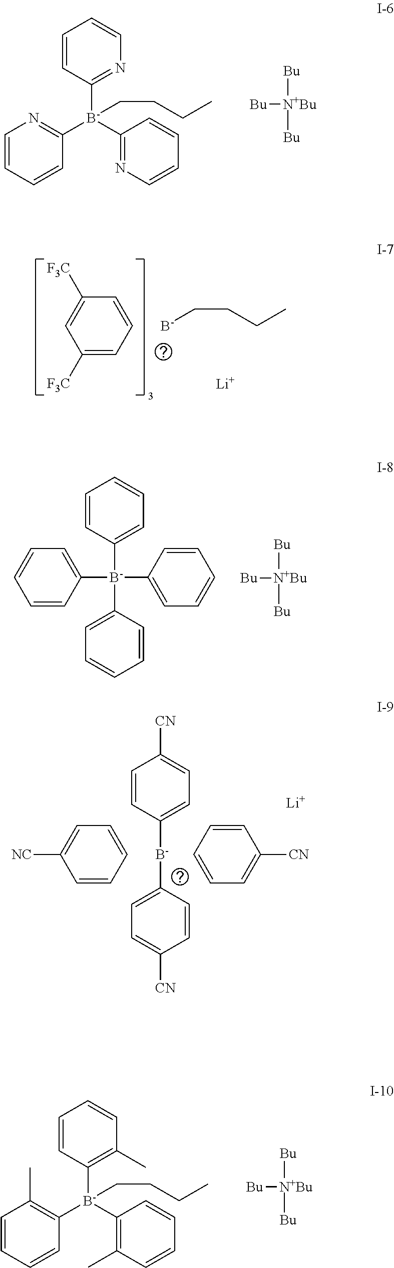

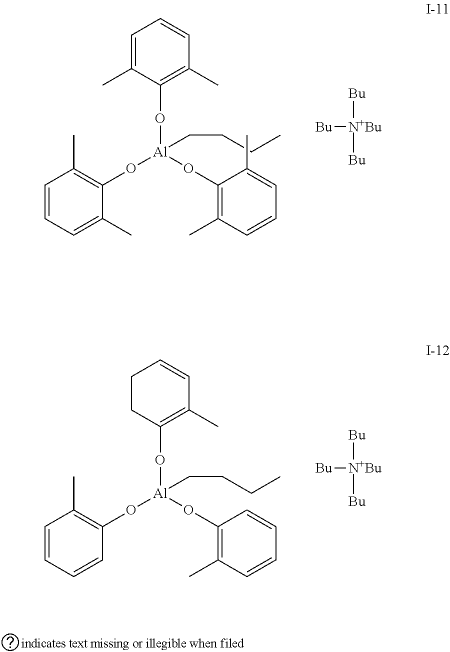

### [Organic Solvent]

The organic solvent used in the present invention is preferably an ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethyl acetate, ethyl trimethyl acetate, acetonitrile, glutaronitrile, adiponitrile, methoxyacetonitrile, 3-methoxypropionitrile, N,N-dimethylformamide, N-methylpyrrolidinone, N-methyl oxazolidinone, N,N′-dimethylimidazolidonone, nitromethane, nitroethane, sulfolane, trimethyl phosphate, dimethyl sulfoxide, and dimethyl sulfoxide phosphate. These may be used alone or in combination of two or more. Among them, at least one selected from the group consisting of ethylene carbonate, propylene carbonate, dimethyl carbonate, diethyl carbonate and ethyl methyl carbonate is preferred. In particular, a combination of a high-viscosity (high-dielectric constant) solvent (for example, having a relative permittivity E of 30 or more) such as ethylene carbonate or propylene carbonate with a low-viscosity solvent (for example, having a viscosity of up to 1 m·Pas) such as dimethyl carbonate, ethyl methyl carbonate or diethyl carbonate is more preferred because the dissociation ability and the ionic mobility of the electrolytic salt are improved.

However, the organic solvent (non-aqueous solvent) used in the present invention is not limited to the aforementioned examples.

In addition, the solvent may contain a cyclic carbonate ester having an unsaturated bond because the chemical stability of the liquid electrolyte is further improved. For example, at least one selected from the group consisting of a vinylene carbonate compound, a vinyl ethylene carbonate compound, and a methylene ethylene carbonate compound is used as the cyclic carbonate ester having an unsaturated bond.

Examples of the vinylene carbonate compound include vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one.

Examples of the vinyl ethylene carbonate compound include vinyl ethylene carbonate (4-vinyl-1,3-dioxolan-2-one), 4-methyl-4-vinyl-1,3-dioxolan-2-one, 4-ethyl-4-vinyl-1,3-dioxolan-2-one, 4-n-propyl-4-vinyl-1,3-dioxolan-2-one, 5-methyl-4-vinyl-1,3-dioxolan-2-one, 4,4-divinyl-1,3-dioxolan-2-one, and 4,5-divinyl-1,3-dioxolan-2-one.

Examples of the methylene ethylene carbonate compound include 4-methylene-1,3-dioxolan-2-one, 4,4-dimethyl-5-methylene-1,3-dioxolan-2-one and 4,4-diethyl-5-methylene-1,3-dioxolan-2-one.

These may be used alone or as a mixture of two or more thereof. Of these, vinylene carbonate is preferable because a high effect is obtained.

### (Electrolyte)

Electrolyte that can be used in the liquid electrolyte of the present invention includes a metal or a salt thereof and a metal ion belong to Group I or Group II of the Periodic Table or a salt thereof are preferable. The electrolyte is suitably selected depending on the purpose of a liquid electrolyte. For example, lithium salts, potassium salts, sodium salts, calcium salts, and magnesium salts can be mentioned. In a case where the liquid electrolyte is used in a secondary battery or the like, from the viewpoint of the output power of the secondary battery, a lithium salt is preferred. In a case of using the liquid electrolyte of the present invention as the electrolyte of a non-aqueous liquid electrolyte for lithium secondary batteries, it is desirable to select a lithium salt as the salt of the metal ion. The lithium salt is not particularly limited as long as it is a lithium salt that is usually used in the electrolyte of a non-aqueous liquid electrolyte for lithium secondary batteries, but for example, the salts described below are preferred.
(L-1) Inorganic lithium salt: inorganic fluoride salt such as LiPF₆, LiBF₄, LiAsF₆, LiSbF₆; perhalogenic acid salts such as LiClO₄, LiBrO₄, LiIO₄; and inorganic chloride salt such as LiAlCl₄, and the like.
(L-2) Organic lithium salt containing fluorine: perfluoroalkanesulfonic acid salt such as LiCF₃SO₃; perfluoroalkanesulfonylimide salts such as LiN(CF₃SO₂)₂, LiN(CF₃CF₂SO₂)₂, LiN(FSO₂)₂, and LiN(CF₃SO₂)(C₄F₉SO₂); perlluoroalkanesulfonylmethide salts such as LiC(CF₃SO₂)₃; fluoroalkyl fluorophosphoric acid salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃], and the like.
(L-3) Oxalatoborate salts: lithium bis(oxalate)borate, lithium difluoro(oxalate)borate, and the like.

Among these, LiPF₆, LiBF₄, LiAsF₆, LiSbF₆, LiClO₄, Li(Rf¹ SO₃), LiN(Rf¹SO₂)₂, LiN(FSO₂)₂, and LiN(Rf¹SO₂)(Rf²SO₂)₂ are preferred; and lithium imide salts such as LiPF₆, LiBF₄, LiN(Rf¹SO₂)₂, LiN(FSO₂)₂ and LiN(Rf¹SO₂)(Rf²SO₂)₂ are more preferred. Herein, Rf¹ and Rf² each represent a perfluoroalkyl group.

Meanwhile, as for the lithium salt that is used in the liquid electrolyte, one kind may be used alone, or any two or more kinds may be used in combination.

The ion of metal belong to Group I or Group II of the Periodic Table of Elements or the salt thereof is added to the liquid electrolyte in such an amount that the electrolyte is contained at a preferred salt concentration to be mentioned in the method for preparing the liquid electrolyte below. The salt concentration is selected according to the purpose of the liquid electrolyte, but the content is usually from 10 mass % to 50 mass %, and more preferably from 15 mass % to 30 mass %, relative to the total mass of the liquid electrolyte. When evaluated as the ionic concentration, the salt concentration need only be calculated in terms of the salt with an advantageously applied metal.

### (Other Components)

The liquid electrolyte of the present invention may contain at least one selected from the group consisting of a forming agent of a film on a negative electrode, a flame retardant and an overcharge preventing agent. The content ratio of these functional additives in the non-aqueous liquid electrolyte is not particularly limited but is each preferably 0.001% by mass to 10% by mass with respect to the whole non-aqueous liquid electrolyte. These added compounds act during disorder due to overcharge, and allows capacity maintenance characteristics and cycling characteristics to be improved after preserving at high temperature.

### [Method of Preparing Liquid Electrolyte and the Like]

The non-aqueous liquid electrolyte for a secondary battery of the present invention is prepared by a usual method in such a manner that the above-mentioned each component is dissolved in the non-aqueous liquid electrolyte solvent including an example using a lithium salt as a salt of metal ion.

The term “non-aqueous” as used in the present invention means that water is substantially not contained, and a small amount of water may be contained as long as the effects of the present invention are not impaired. In consideration of obtaining good properties, water is preferably contained in an amount of up to 200 ppm and more preferably up to 100 ppm. Although the lower limit is not particularly restricted, it is practical for the water content to be 10 ppm or more in consideration of inevitable incorporation. Although the viscosity of the liquid electrolyte of the present invention is not particularly limited, the viscosity at 25° C. is preferably 10 to 0.1 mPa·s, more preferably 5 to 0.5 mPa·s.

### (Kit)

The liquid electrolyte of the present invention may be formed as a kit composed of plural liquids, powders or the like. For example, the liquid electrolyte may be in a form that a first agent (first liquid) is composed of a metal salt and an organic solvent, a second agent (second liquid) is composed of the polymerizable monomer and an organic solvent, and the two liquids are mixed to prepare a liquid before use. At this time, in the kit of the present invention, the polymerization initiator is contained in the first agent, the second agent and/or another agent (third agent). This fact allows an interaction between the above-mentioned polymerizable monomer and the above-mentioned polymerization initiator to be effectively obtained. The aforementioned contents of the various components are preferably such that the contents are in the ranges described above after the components are mixed.

### [Secondary Battery]

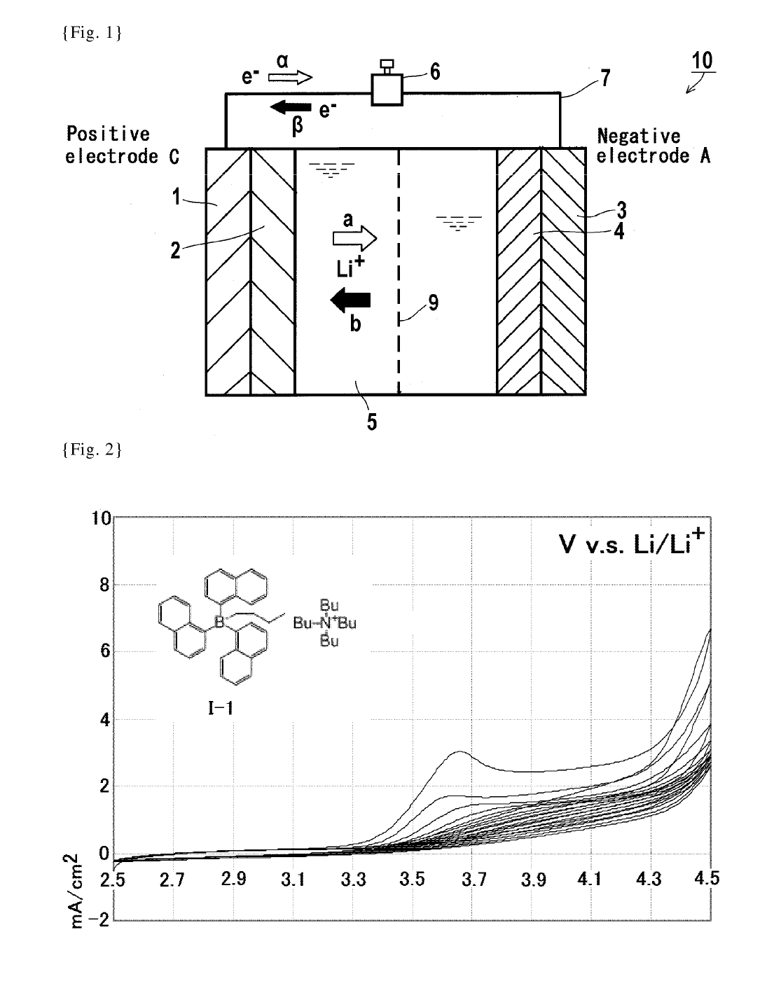

In the present invention, a non-aqueous secondary battery preferably contains the above-mentioned non-aqueous liquid electrolyte. A preferable embodiment is described while referring to FIG. 1 schematically illustrating a mechanism of a lithium ion secondary battery. The lithium ion secondary battery 10 of the present embodiment includes the above-described non-aqueous liquid electrolyte 5 for a secondary battery of the present invention, a positive electrode C (current collector for positive electrode I, positive electrode active material layer 2) capable of insertion and release of lithium ions, and a negative electrode A (current collector for negative electrode 3, negative electrode active material layer 4) capable of insertion and discharge, or dissolution and precipitation, of lithium ions. In addition to these essential members, the lithium secondary battery may be also constructed to include a separator 9 that is disposed between the positive electrode and the negative electrode, current collector terminals (not shown), and an external case (not shown), in consideration of the purpose of using the battery, the form of the electric potential, and the like. According to the necessity, a protective element may also be mounted in at least any one side of the interior of the battery and the exterior of the battery. By employing such a structure, transfer of lithium ions a and b occurs in the liquid electrolyte 5, and charging a and discharging β can be carried out. Thus, operation and accumulation can be carried out by means of an operating means 6 through the circuit wiring 7. The configuration of the lithium secondary battery, which is a preferable embodiment of the present invention, will be described in detail below.

### (Battery Shape)

There are no particular limitations on the battery shape that is applied to the lithium secondary battery of the present embodiment, and examples of the shape include a bottomed cylindrical shape, a bottomed rectangular shape, a thin flat shape, a sheet shape, and a paper shape. The lithium secondary battery of the present embodiment may have any of these shapes. Furthermore, an atypical shape such as a horseshoe shape or a comb shape, which is designed in consideration of the form of the system or device into which the lithium secondary battery is incorporated, may also be used. Among them, from the viewpoint of efficiently releasing the heat inside of the battery to the outside thereof, a rectangular shape such as a bottomed rectangular shape or a thin flat shape, which has at least one relatively flat and large-sized surface, is preferred.

In a battery having a bottomed cylindrical shape, since the external surface area relative to the power generating element to be charged is small, it is preferable to design the battery such that the Joule heating that is generated due to the internal resistance at the time of charging or discharging is efficiently dissipated to the outside. Furthermore, it is preferable to design the lithium secondary battery such that the filling ratio of a substance having high heat conductibility is increased so as to decrease the temperature distribution inside the battery.

With regard to the bottomed rectangular shape, it is preferable that the value of the ratio of twice the area of the largest surface, S (the product of the width and the height of the external dimension excluding terminal areas, unit: cm²) and the external thickness of the battery, T (unit: cm), 2S/T, be 100 or greater, and more favorably 200 or greater.

### (Battery-Constituting Members)

The lithium secondary battery of the present embodiment is constituted to include the liquid electrolyte 5, an electrode mixture of a positive electrode C and a negative electrode A, and basic member of the separator 9, based on Fig. These various members will be described below. The lithium secondary battery of the present invention includes at least the non-aqueous liquid electrolyte for batteries of the present invention as the liquid electrolyte.

### (Electrode Mixtures)

An electrode mixture is a composite obtained by applying an active substance, and a dispersion of an electroconductive agent, a binder, a filler and the like on a current collector (electrode substrate). For a lithium battery, a positive electrode mixture in which the active substance is a positive electrode active substance, and a negative electrode mixture in which the active substance is a negative electrode active substance are usually used. Next, each component and the like in dispersions composing the electrode mixture (composition for electrode) is described.

### Positive Electrode Active Substance

As a positive electrode active substance, a particulate positive electrode active substance may be used. Specifically, as the positive electrode active substance, a transition metal oxide which is capable of reversible insertion and release of lithium ions can be used, but it is preferable to use a lithium-containing transition metal oxide. Suitable examples of a lithium-containing transition metal oxide that is preferably used as a positive electrode active substance, include oxides containing one or more of lithium-containing Ti, lithium-containing V, lithium-containing Cr, lithium-containing Mn, lithium-containing Fe, lithium-containing Co, lithium-containing Ni, lithium-containing Cu, lithium-containing Mo, and lithium-containing W. Furthermore, alkali metals other than lithium (elements of Group 1 (Ia) and Group 2 (IIa) of the Periodic Table), and/or Al, Ga, In, Ge, Sn, Pb, Sb, Bi, Si, P, B and the like may also be incorporated. The amount of incorporation is preferably from 0 mol % to 30 mol % relative to the amount of the transition metal.

Among the lithium-containing transition metal oxides that are preferably used as the positive electrode active substance, a substance synthesized by mixing a lithium compound and a transition metal compound (herein, the transition metal refers to at least one selected from Ti, V, Cr, Mn, Fe, Co, Ni, Mo, and W) such that the total molar ratio of lithium compound/transition metal compound is 0.3 to 2.2.

Furthermore, among the lithium compound/transition metal compound, materials containing Li_{g}M3O₂ (wherein M3 represents one or more elements selected from Co, Ni, Fe, and Mn; and g represents 0 to 1.2), or materials having a spinel structure represented by LiₕM4₂O (wherein M4 represents Mn; and h represents 0 to 2) are particularly preferred. As M3 and M4 described above, Al, Ga, In, Ge, Sn, Pb, Sb, Bi, Si, P, B, or the like may also be incorporated in addition to the transition metal. The amount of incorporation is preferably from 0 mol % to 30 mol % relative to the amount of the transition metal.

Among the materials containing Li_{g}M3O₂ and the materials having a spinel structure represented by LiₕM4₂O₄, Li_{g}CoO₂, Li_{g}NiO₂, Li_{g}MnO₂, Li_{g}CoⱼNi₁₋ⱼO₂, LiₕMn₂O₄, LiNiⱼMn₁₋ⱼO₂, LiCoⱼNiₕAl₁₋ⱼ₋ₕO₂, LiMnₕAl₂₋ₕO₄, and LiMnₕNi₂₋ₕO₄ (wherein in the respective formulas, g represents 0.02 to 1.2; j represents 0.1 to 0.9; and h represents 0 to 2) are particularly preferred; and Li_{g}CoO₂, LiMn₂O₄, LiNi_{0.85}Co_{0.01}Al_{0.05}O₂ and LiNi_{0.33}Co_{0.33}Mn_{0.33}O₂ are most preferred. From the viewpoints of high capacity and high power output, among those described above, an electrode containing Ni is more preferred. Herein, the g value and the h value are values prior to the initiation of charging and discharging, and are values that increase or decrease as charging or discharging occurs. Specific examples thereof include LiCoO₂, LiNi_{0.5}Mn_{0.5}O₂, LiNi_{0.85}Co_{0.01}Al_{0.05}O₂, LiNi_{0.33}Co_{0.33}Mn_{0.33}O₂, LiMn_{1.8}Al_{0.2}O₄ and LiMn_{1.5}Ni_{0.5}O₄.

Preferred examples of the transition metal of the lithium-containing transition metal phosphate compound include V, Ti, Cr, Mn, Fe, Co, Ni, and Cu, and specific examples of the compound include iron phosphates such as LiFePO₄, Li₃Fe₂(PO₄)₃, and LiFeP₂O₇; cobalt phosphates such as LiCoPO₄; and compounds in which a portion of the transition metal atoms that constitute the main component of these lithium-transition metal phosphate compounds has been substituted by another metal such as Al, Ti, V, Cr, Mn, Fe, Co, Li, Ni, Cu, Zn, Mg, Ga, Zr, Nb, or Si.

The average particle size of the positive electrode active substance used in the non-aqueous electrolyte secondary battery of the present invention is not particularly limited, but the average particle size is preferably from 0.1 μm to 50 μm. The specific surface area is not particularly limited, but specific surface area as measured by the BET method is preferably from 0.01 m²/g to 50 m²/g. Furthermore, the pH of the supernatant obtainable when 5 g of the positive electrode active substance is dissolved in 100 mL of distilled water is preferably from 7 to 12.

In order to adjust the positive electrode active substance to a predetermined particle size, a well-known pulverizer or classifier may be used. For example, a mortar, a ball mill, a vibrating ball mill, a vibrating mill, a satellite ball mill, a planetary ball mill, a swirling air flow jet mill, or a sieve is used. The positive electrode active substance obtained according to the calcination method may be used after washing the substance with water, an acidic aqueous solution, an alkaline aqueous solution, or an organic solvent.

### Negative Electrode Active Substance

There are no particular limitations on the negative electrode active substance, as long as the negative electrode active substance is capable of reversible insertion and release of lithium ions, and examples thereof include carbonaceous materials, metal oxides such as tin oxide and silicon oxide, metal composite oxides, simple lithium substance or lithium alloys such as a lithium-aluminum alloy, and metals capable of forming an alloy with lithium, such as Sn and Si.

For these materials, one kind may be used alone, or two or more kinds may be used in any combination at any proportions. Among them, carbonaceous materials or lithium composite oxides are preferably used from the viewpoint of safety.

Furthermore, the metal composite oxides are not particularly limited as long as the materials are capable of adsorption and release of lithium, but it is preferable for the composite oxides to contain titanium and/or lithium as constituent components, from the viewpoint of high current density charging-discharging characteristics.

A carbonaceous material that is used as a negative electrode active substance is a material which is substantially composed of carbon. Examples thereof include petroleum pitch, natural graphite, artificial graphite such as vapor-grown graphite, and carbonaceous materials obtained by firing various synthetic resins such as PAN-based resins and furfuryl alcohol resins. Further, the examples include various carbon fibers such as PAN-based carbon fibers, cellulose-based carbon fibers, pitch-based carbon fibers, vapor-grown carbon fibers, dehydrated PVA-based carbon fibers, lignin carbon fibers, vitreous carbon fibers, and activated carbon fibers; mesophase microspheres, graphite whiskers, and tabular graphite.

These carbonaceous materials may be classified into hardly graphitized carbon materials and graphite-based carbon materials, according to the degree of graphitization. Besides, it is preferable that the carbonaceous materials have the plane spacing, density, and size of crystallites described in JP-A-62-22066, JP-A-2-6856, and JP-A-3-45473. The carbonaceous materials are not necessarily single materials, and a mixture of natural graphite and an artificial graphite as described in JP-A-5-90844, a graphite having a coating layer as described in JP-A-6-4516, and the like can also be used.

In regard to the metal oxides and metal composite oxides that are negative electrode active substances used in the non-aqueous secondary battery, at least one of these may be included. The metal oxides and metal composite oxides are particularly preferably amorphous oxides, and furthermore, chalcogenides which are reaction products of metal elements and the elements of Group 16 of the Periodic Table are also preferably used. The term amorphous as used herein means that the substance has a broad scattering band having an apex at a 20 value in the range of 20° to 40°, as measured by an X-ray diffraction method using CuKa radiation, and the substance may also have crystalline diffraction lines. The highest intensity obtainable among the crystalline diffraction lines exhibited at a 20 value in the range of from 40° to 70° is preferably 100 times or less, and more preferably 5 times or less, than the diffraction line intensity of the apex of the broad scattering band exhibited at a 20 value in the range of from 20° to 40°, and it is particularly preferable that the substance does not have any crystalline diffraction line.

Among the group of compounds composed of the amorphous oxides and chalcogenides, amorphous oxides and chalcogenides of semi-metallic elements are more preferred, and oxides and chalcogenides formed from one kind alone or combinations of two or more kinds of the elements of Group 13 (IIIB) to Group 15 (VB) of the Periodic Table, Al, Ga, Si, Sn, Ge, Pb, Sb and Bi are particularly preferred. Specific preferred examples of the amorphous oxides and chalcogenides include, for example, Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃ as for metal compounds. Furthermore, these may also be composite oxides with lithium oxide, for example, Li₂SnO₂.

The average particle size of the negative electrode active substance used in the non-aqueous secondary battery of the present invention is preferably from 0.1 μm to 60 μm. In order to adjust the negative electrode active substance to a predetermined particle size, a well-known pulverizer or classifier may be used. For example, a mortar, a ball mill, a sand mill, a vibrating ball mill, a satellite ball mill, a planetary ball mill, a swirling air flow jet mill, and a sieve are favorably used. At the time of pulverization, wet pulverization of using water or an organic solvent such as methanol to co-exist with the negative electrode active substance can also be carried out as necessary. In order to obtain a desired particle size, it is preferable to perform classification. There are no particular limitations on the classification method, and a sieve, an air classifier or the like can be used as necessary. Classification may be carried out by using a dry method as well as a wet method.

The chemical formula of the compound obtained by the calcination method can be obtained by using an inductively coupled plasma (ICP) emission spectroscopic method as a measurement method, and computed from the mass difference of the powder measured before and after calcination, as a convenient method.

In the present invention, suitable examples of the negative electrode active substance that can be used together with the amorphous oxide negative electrode active substances containing Sn, Si and Ge, include carbon materials that are capable of adsorption and release of lithium ions or lithium metal, as well as lithium, lithium alloys, and metal capable of alloying with lithium.

In the present invention, it is preferable to use lithium titanate, more specifically lithium titanium oxide (Li[Li_{1/3}Ti_{5/3}]O₄), as an active material of the negative electrode.

### Electroconductive Material

As for the electroconductive material, any material may be used as long as it is an electron conductive material which does not cause a chemical change in a constructed secondary battery, and any known electroconductive material can be used.

Usually, electroconductive materials such as natural graphite (scale-like graphite, flaky graphite, earthly graphite, and the like), artificial graphite, carbon black, acetylene black, Ketjen black, carbon fibers, metal powders (copper, nickel, aluminum, silver (described in JP-A-63-10148, 554), and the like), metal fibers, and polyphenylene derivatives (described in JP-A-59-20,971) can be incorporated alone or as mixtures thereof. Among them, a combination of graphite and acetylene black is particularly preferred. The amount of addition of the electroconductive agent is preferably from 0.1 mass % to 50 mass %, and more preferably from 0.5 mass % to 30 mass %. In the case of carbon or graphite, the amount of addition is particularly preferably from 0.5 mass % to 15 mass %.

### Binder

Examples of the binder include polysaccharides, thermoplastic resins, and polymers having rubber elasticity, and among them, preferred examples include emulsions (latexes) or suspensions of starch, carboxymethyl cellulose, cellulose, diacetyl cellulose, methyl cellulose, hydroxyethyl cellulose, hydroxypropyl cellulose, sodium alginate; water-soluble polymers such as poly(acrylic acid), poly(sodium acrylate), polyvinylphenol, poly(vinyl methyl ether), poly(vinyl alcohol), polyvinylpyrrolidone, polyacrylonitrile, polyacrylamide, poly(hydroxy(meth)acrylate), and a styrene-maleic acid copolymer; poly(vinyl chloride), polytetrafluoroethylene, poly(vinylidene fluoride), a tetrafluoroethylene-hexafluoropropylene copolymer, a vinylidene fluoride-tetrafluoroethylene-hexafluoropropylene copolymer, polyethylene, polypropylene, an ethylene-propylene-diene terpolymer (EPDM), a sulfonated EPDM, a poly(vinyl acetal) resin, (meth)acrylic acid ester copolymers containing (meth)acrylic acid esters such as methyl methacrylate and 2-ethylhexyl acrylate, a (meth)acrylic acid ester-acrylonitrile copolymer, a poly(vinyl ester) copolymer containing a vinyl ester such as vinyl acetate, a styrene-butadiene copolymer, an acrylonitrile-butadiene copolymer, polybutadiene, a neoprene rubber, a fluorine rubber, poly(ethylene oxide), a polyester polyurethane resin, a polyether polyurethane resin, a polycarbonate polyurethane resin, a polyester resin, a phenolic resin, and an epoxy resin. More preferred examples include a poly(acrylic acid ester)-based latex, carboxymethyl cellulose, polytetrafluoroethylene, and poly(vinylidene fluoride).

As for the binder, one kind may be used alone, or two or more kinds may be used as mixtures. If the amount of addition of the binder is small, the retention power and the aggregating power of the electrode mixture are weakened. If the amount of addition is too large, the electrode volume increases, and the capacity per unit volume or unit mass of the electrode is decreased. For such reasons, the amount of addition of the binder is preferably from 1 mass % to 30 mass %, and more preferably from 2 mass % to 10 mass %.

### Filler

The electrode mixture may contain a filler. Regarding the material that forms the filler, any fibrous material that does not cause a chemical change in the secondary battery of the present invention can be used. Usually, fibrous fillers formed from olefinic polymers such as polypropylene and polyethylene, and materials such as glass and carbon are used. The amount of addition of the filler is not particularly limited, but the amount of addition is preferably from 0 mass % to 30 mass %.

### Current Collector

As the current collector for the positive and negative electrodes, an electron conductor that does not cause a chemical change in the non-aqueous electrolyte secondary battery of the present invention is used. Preferred examples of the current collector for the positive electrode include aluminum, stainless steel, nickel, and titanium, as well as aluminum or stainless steel treated with carbon, nickel, titanium, or silver on the surface. Among them, aluminum and aluminum alloys are more preferred.

Preferred examples of the current collector for the negative electrode include aluminum, copper, stainless steel, nickel, and titanium, and more preferred examples include aluminum, copper and copper alloys.

Regarding the shape of the current collector, a film sheet-shaped current collector is usually used, but a net-shaped material, a film sheet formed by punching, a lath material, a porous material, a foam, a material obtained by molding a group of fibers, and the like can also be used. The thickness of the current collector is not particularly limited, but the thickness is preferably from 1 μm to 500 μm. Furthermore, it is also preferable to provide surface unevenness on the surface of the current collector through a surface treatment.

Electrode mixtures for lithium secondary batteries are formed by members appropriately selected from these materials.

### (Separator)

The separator used in the non-aqueous secondary battery of the present invention is not particularly limited as long as the separator is formed of a material which electronically insulates the positive electrode and the negative electrode, and has mechanical strength, ion permeability, and oxidation-reduction resistance at the surfaces in contact with the positive electrode and the negative electrode. Examples of such a material that may be used include porous polymer materials or inorganic materials, organic-inorganic hybrid materials, and glass fibers. These separators preferably have a shutdown function for securing safety, that is, a function of increasing resistance by blocking the voids at 80° C. or more, and thereby cutting off the electric current, and the blocking temperature is preferably from 90° C. to 180° C.

The shape of the pores of the separator is usually circular or elliptical, and the size is from 0.05 μm to 30 μm, and preferably from 0.1 μm to 20 μm. Furthermore, as in the case of producing the material by an extension method or a phase separation method, a material having rod-shaped or irregularly shaped pores may also be used. The proportion occupied by these pores, that is, the pore ratio, is 20% to 90%, and preferably 35% to 80%.

Regarding the polymer materials described above, a single material such as cellulose nonwoven fabric, polyethylene, or polypropylene may be used, or a compositized material of two or more kinds may also be used. A laminate of two or more kinds of finely porous films that are different in the pore size, pore ratio, pore blocking temperature and the like, is preferred.

As the inorganic material, oxides such as alumina and silicon dioxide, nitrides such as aluminum nitride and silicon nitride, and sulfates such as barium sulfate and calcium sulfate are used, and a particle-shaped or fiber-shaped material is used. Regarding the form, a thin film-shaped material such as a nonwoven fabric, a woven fabric, or a finely porous film is used. In the case of a thin film-shaped material, a material having a pore size of from 0.01 μm to 1 μm and a thickness of from 5 μm to 50 μm is favorably used. In addition to the independent thin film-shaped materials described above, a separator obtained by forming a composite porous layer containing particles of the inorganic substance described above, as a surface layer of the positive electrode and/or the negative electrode by using a binder made of a resin, can be employed. For example, a separator in which alumina particles having a 90% particle size of less than 1 μm are formed on both surfaces of the positive electrode as porous layers by using a binder of a fluororesin, may be used.

### (Preparation of Non-Aqueous Secondary Battery)

As the shape of the non-aqueous secondary battery of the present invention, any form such as a sheet form, a rectangular form, or a cylindrical form can be applied as described above. The mixture of the positive electrode active substance or the negative electrode active substance is mainly used after being applied (coated) on a current collector, dried, and compressed.

In a battery having a bottomed cylindrical shape, since the external surface area relative to the power generating element to be charged is small, it is preferable to design the battery such that the Joule heating that is generated due to the internal resistance at the time of charging or discharging is efficiently dissipated to the outside. Furthermore, it is preferable to design the lithium secondary battery such that the filling ratio of a substance having high heat conductibility is increased so as to decrease the temperature distribution inside the battery.

First, a negative electrode active substance is mixed with a solution prepared by dissolving a binder, a filler and the like that are used as desired in an organic solvent, and thus a negative electrode mixture is prepared in a slurry form or in a paste form. The negative electrode mixture thus obtained is uniformly applied over the entire surface of both sides of a metal core as a current collector, and then the organic solvent is removed to form a negative electrode mixture layer. Furthermore, the laminate of the current collector and the negative electrode mixture layer is rolled by using a roll pressing machine or the like to produce a laminate having a predetermined thickness, and thereby, a negative electrode sheet (electrode sheet) is obtained. At this time, the application method for each agent, the drying of applied matter, and the formation method for positive and negative electrodes may conform to the usual method.

In the present embodiment, a cylindrical battery has been explained as an example, but the present invention is not limited to this. For example, positive and negative electrode sheets produced by the methods described above are superimposed with a separator interposed therebetween, and then the assembly may be processed directly into a sheet-like battery. Alternatively, a rectangular-shaped battery may be formed by folding the assembly, inserting the assembly into a rectangular can, electrically connecting the can with the sheet, subsequently injecting an electrolyte, and sealing the opening by using an opening sealing plate.

For the can or the lead plate, a metal or an alloy having electrical conductibility can be used. For example, metals such as iron, nickel, titanium, chromium, molybdenum, copper, and aluminum, or alloys thereof are favorably used.

For the welding method that may be used when a cap, a can, a sheet, and a lead plate are welded, any known methods (for example, an electric welding method using a direct current or an alternating current, a laser welding method, an ultrasonic welding method, and the like) can be used. As the sealing agent for sealing an opening, any conventionally known compounds such as asphalt, and mixtures can be used.

### [Use of Non-Aqueous Secondary Battery]

Non-aqueous secondary batteries of the present invention are applied to various applications since the secondary batteries have satisfactory cycle characteristics.

There are no particular limitations on the application embodiment for the non-aqueous secondary battery, but in the case of mounting the non-aqueous secondary battery in electronic equipment, examples of the equipment include notebook computers, pen-input personal computers, mobile personal computers, electronic book players, mobile telephones, cordless phone handsets, pagers, handy terminals, portable facsimiles, portable copying machines, portable printers, headphone stereo sets, video movie cameras, liquid crystal television sets, handy cleaners, portable CDs, mini disc players, electric shavers, transceivers, electronic organizers, calculators, memory cards, portable tape recorders, radios, backup power supplies, and memory cards. Other additional applications for consumer use include automobiles, electromotive vehicles, motors, lighting devices, toys, game players, load conditioners, timepieces, strobes, cameras, and medical devices (pacemakers, hearing aids, shoulder massaging machines, and the like). Furthermore, the non-aqueous secondary battery can be used as various batteries for munition and space batteries. Also, the non-aqueous secondary battery can be combined with a solar cell.

The metal ion that may be used for charge transport in the secondary battery is not particularly limited and it is preferable to use the ion of a metal belonging to Group 1 or 2 of the Periodic Table. Among them, ions such as lithium ion, sodium ion, magnesium ion, calcium ion and aluminum ion are preferably used. As for the general technical matters of secondary batteries using lithium ions, a lot of literatures and books including the references mentioned at the beginning of the specification are published and referenced therefor. In addition, Journal of Electrochemical Society; Electrochemical Science and Technology (US, 1980, Vol. 127, pp. 2097-2099) and the like can be referenced for the secondary battery using sodium ions. Nature 407, pp. 724-727 (2000) and the like can be referenced for magnesium ion. J. Electrochem. Soc., Vol. 138, 3536 (1991) and the like can be referenced for calcium ion. The present invention is preferably applied to lithium ion secondary batteries because they are widely spread but the present invention also has a desired effect on other articles than the lithium ion secondary batteries and should not be construed as being limited thereto.

### EXAMPLES

Hereinafter, the present invention will be described in more detail with reference to examples, but the present invention is not limited to these examples.

### Reference Example

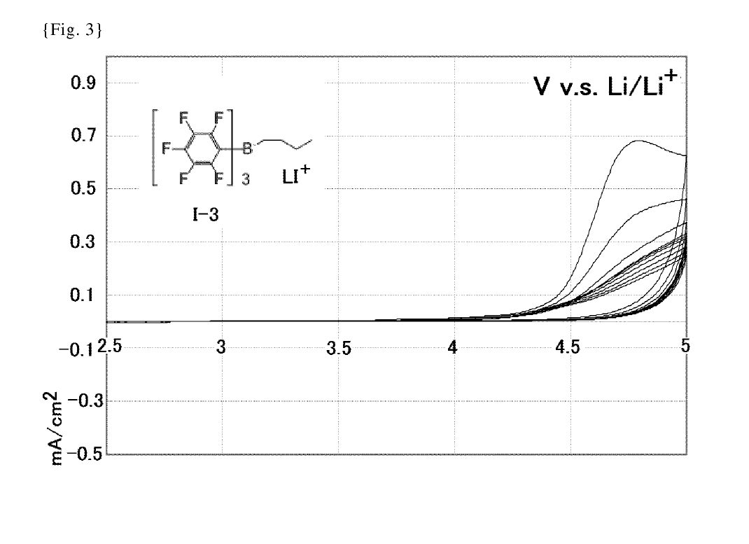

The after-mentioned polymerization initiators I-1 and I-3 were added in a liquid electrolyte of 1M LiPF₆ ethylene carbonate/diethyl carbonate at a volume ratio of 1:1 by a concentration of 0.1 mol/L to prepare sample solutions. Voltammetry (a sweep rate of 5 mV/sec) at room temperature (approximately 25° C.) was performed for each of the sample solutions by using potentiostat (VMP3 (trade name) manufactured by BioLogic) in a system of tripolar electrochemical measurement using lithium, a platinum plate and lithium for working electrode, counter electrode and reference electrode, respectively. Each voltammogram in which an observed oxidation current peak was seen was shown in FIGS. 2 and 3.

It is found from this result that the above-mentioned compounds I-1 and I-3 react at 3.5 to 4 V and 4.5 to 5 V respectively to produce an active species (a radical and a Lewis acid) in the liquid.

### Example/Comparative Example

### Preparation of Liquid Electrolyte

The polymerization initiators and polymerizable monomers shown in Table 1 were added to a liquid electrolyte of 1M LiPF₆ ethylene carbonate/diethyl carbonate at a volume ratio of 1:1 by the amount described in Table 1 to prepare a test liquid electrolyte.

### Preparation of 2032-Type Coin Battery

A positive electrode was produced by using an active material:lithium nickel manganese cobalt oxide (LiNi1/3Mn1/3Co1/3O₂) 85% by mass, a conductive assistant: carbon black 7% by mass and a binder: PVDF (polyvinylidene fluoride) 8% by mass, and a negative electrode was produced by using an active material: graphite 86% by mass, a conductive assistant: carbon black 6 wt % and a binder: PVDF 8% by mass. A separator was 25 um thick made of polypropylene. A 2032-type coin battery was produced for each test liquid electrolyte by using the above-mentioned positive and negative electrodes and separator to evaluate the following items. The results are shown in Table 1.

### <Evaluation of Initial Discharge Capacity>

The coin battery produced as described above was used, and in a thermostatic chamber at 30° C., the battery was subjected to constant current charging 0.4 mA (0.2 C) until the battery voltage reached the voltage described in Table I. Thereafter, constant-current discharge was performed until battery voltage became 2.75 V at −0.4 mA (0.2 C). This process was repeated five times. The five-time discharge capacity considers as the initial discharge capacity.

### <Capacity Maintaining Ratio-300th Cycles>

The 2032-type coin battery produced by the method described above was used, and in a thermostatic chamber at 60° C., the battery was subjected to constant current charging at 1 C until the battery voltage reached 4.4 V at 4.0 mA, subsequently to charging at a constant voltage of 4.4 V until the current value reached 0.12 mA or for 2 hours, and then to constant current discharging at 1 C until the battery voltage reached 2.75 V at 4.0 mA. This was defined as 1 cycle. This procedure was repeated up to 300th cycles. The discharge capacity (mAh) on 300th cycle was measured. Discharge capacity maintaining ratio (%)=(Discharge capacity on 300th cycle/Discharge capacity on 1st cycle)×100

TABLE 1

| | | | | | | Capacity |
|---|---|---|---|---|---|---|
| | | | Poly- | | Initial | maintaining |
| | | | merizable | | capacity | ratio |
| No. | Initiator | (mass %) | monomer | (mass %) | (V) | (%) |
| 101 | I-1 | 0.04 | M-1 | 0.5 | 4.2 | 84 |
| 102 | I-1 | 0.04 | M-2 | 0.5 | 4.2 | 85 |
| 103 | I-4 | 0.04 | M-2 | 0.5 | 4.3 | 84 |
| 104 | I-8 | 0.04 | M-2 | 0.5 | 4.4 | 85 |
| 105 | I-2 | 0.04 | M-3 | 0.5 | 4.4 | 86 |
| 106 | I-2 | 0.04 | M-9 | 0.5 | 4.4 | 89 |
| 107 | I-2 | 0.04 | M-7 | 0.5 | 4.4 | 90 |
| 108 | I-3 | 0.04 | M-1 | 0.5 | 4.7 | 92 |
| 109 | I-3 | 0.04 | M-3 | 0.5 | 4.7 | 91 |
| 110 | I-3 | 0.04 | M-4 | 0.5 | 4.7 | 95 |
| 111 | I-3 | 0.04 | M-5 | 0.5 | 4.7 | 97 |
| 112 | I-3 | 0.04 | M-6 | 0.5 | 4.7 | 95 |
| 113 | I-3 | 0.04 | M-7 | 0.5 | 4.7 | 98 |
| 114 | I-3 | 0.04 | M-8 | 0.5 | 4.7 | 99 |
| 115 | I-6 | 0.04 | M-7 | 0.5 | 4.7 | 98 |
| c11 | none | none | M-1 | 2 | 4.4 | 72 |
| c12 | none | none | M-2 | 2 | 4.4 | 69 |
| c13 | none | none | M-2 | 0.5 | 4.4 | 69 |
| c14 | I-1 | 0.04 | none | none | 4.4 | 70 |
| c15 | I-4 | 0.04 | none | none | 4.4 | 70 |
| c16 | I-5 | 0.04 | none | none | 4.4 | 69 |
| c17 | I-3 | 0.04 | none | none | 4.4 | 73 |
| c18 | none | none | M-7 | 2 | 4.4 | 68 |
| c19 | none | none | M-7 | 0.5 | 4.4 | 70 |
| c20 | none | none | none | none | 4.4 | 69 |

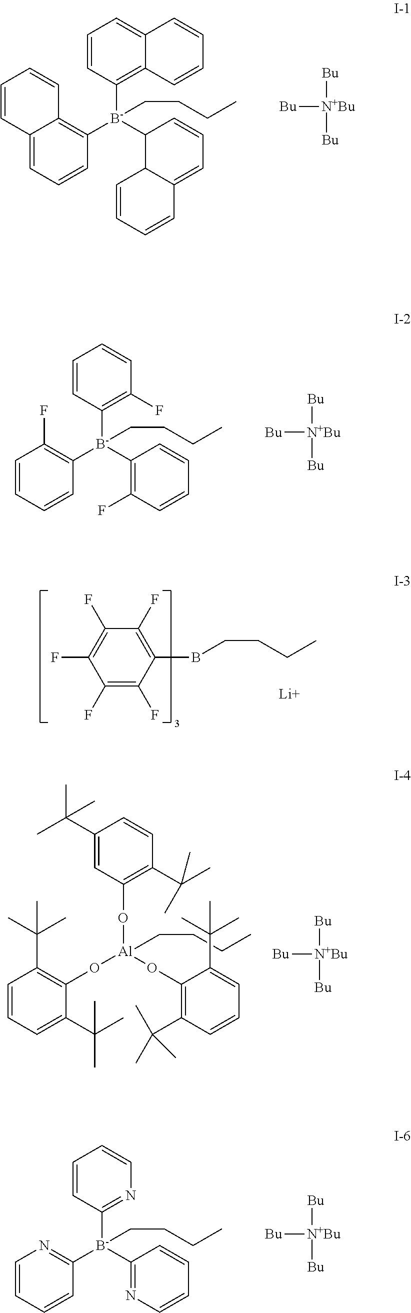

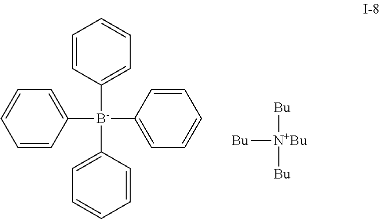

### <Polymerizable Monomer>

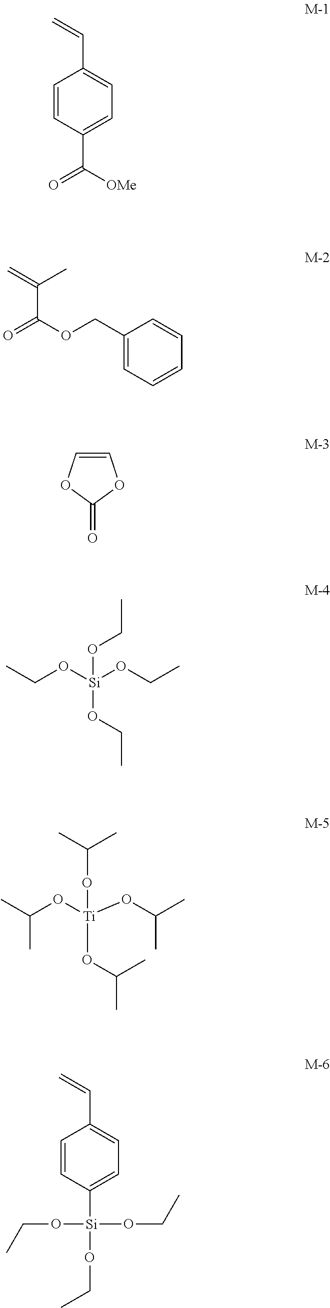

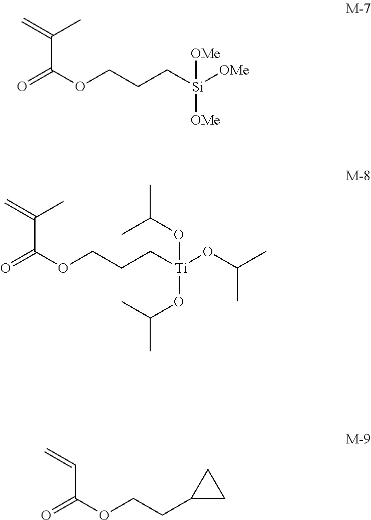

As described above, the non-aqueous liquid electrolyte of the present invention allows the improvement of the performance of cycling characteristics to be achieved. Besides, in Examples according to the present invention, the effect is exhibited even though the added amount of the additives (polymerizable monomers and polymerization initiators) is small. Through Examples, in the present invention, the cycle characteristic is further improved in the case where reactive groups coexist at both terminals of the polymerization monomer (tests 106, 112 to 115) than the case of using a monomer of a radical polymerizable group singly or a polymerizable site such that a reaction is accelerated by a Lewis acid singly. This fact signifies that a film is effectively formed by reactive groups being at both terminals of the polymerization monomer.

Further, in the present invention, it is found that more favorable polymerization initiators are borates having a strong electron withdrawing group on an aryl group like 1-3. The reason therefor is conceived to be that high electron withdrawing property enhances Lewis acidity of organic boranes produced after borates are decomposed, so as to allow more effective polymerized films to be formed.

On the other hand, in the Comparative examples, the case where the added amount of the polymerizable monomers is large or small was described with respect to the case where the initiators do not exist. In this case, the initiators do not exist, so that an efficient polymerized film forming reaction does not progress and the effect of improving cycle characteristic is scarcely obtained. On the contrary, also in the case of adding only the initiators, the polymerized film forming reaction is not caused and the effect of improving cycle characteristic is scarcely obtained.

Having described our invention as related to the present embodiments, it is our intention that the invention not be limited by any of the details of the description, unless otherwise specified, but rather be construed broadly within its spirit and scope as set out in the accompanying claims.

1. A non-aqueous liquid electrolyte for a secondary battery, comprising:
an electrolyte,
a polymerizable monomer,
a polymerization initiator, and
an organic solvent;
the polymerization initiator having a central element, the central element being an element of Group XIII of the Periodic Table, the polymerization initiator being defined in a compound capable of producing a radical and a Lewis acid in a liquid

2. The non-aqueous liquid electrolyte for a secondary battery according to claim 1, wherein the polymerization initiator is a polymerization initiator represented by the following formula (I) or (II): 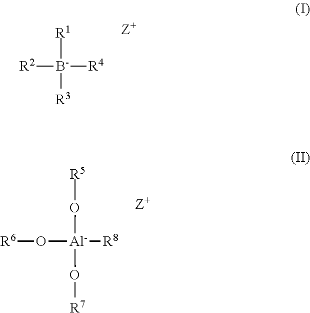
wherein R¹ to R³ each represent an aryl group or a heteroarylgroup; R⁴ represents an alkyl group, an aryl group, or a heteroarylgroup; Z⁺ represents a cation; R⁵ to R⁷ each represent an aryl group or a heteroarylgroup; and R⁸ represents an alkyl group.

3. The non-aqueous liquid electrolyte for a secondary battery according to claim 2, wherein R⁴ in formula (I) is an alkyl group having 1 to 8 carbon atoms.

4. The non-aqueous liquid electrolyte for a secondary battery according to claim 1, wherein the polymerization initiator is a polymerization initiator represented by the following formula (III) or (IV): 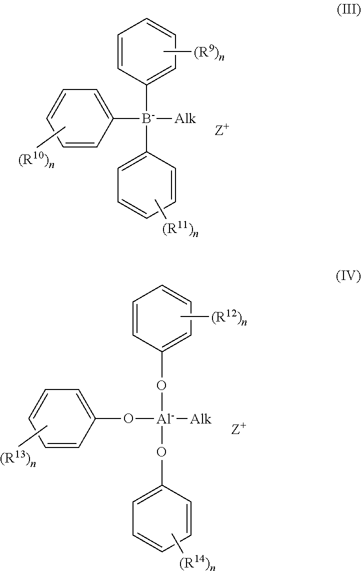
wherein R⁹ to R¹⁴ each represent an alkyl group, a fluoroalkyl group, an alkoxy group, a thioalkoxy group, a cyano group, a halogen atom, or an acyl group; n represents an integer of 0 to 5; Alk represents an alkyl group; and Z⁺ represents a cation.

5. The non-aqueous liquid electrolyte for a secondary battery according to claim 1, wherein the polymerizable monomer is a compound having a radical polymerizable site.

6. The non-aqueous liquid electrolyte for a secondary battery according to claim 1, wherein the polymerizable monomer is a compound having a polymerizable site such that a reaction is accelerated by a Lewis acid.

7. The non-aqueous liquid electrolyte for a secondary battery according to claim 1, wherein the polymerizable monomer is a compound having both a radical polymerizable site and a polymerizable site such that a reaction is accelerated by a Lewis acid.

8. The non-aqueous liquid electrolyte for a secondary battery according to claim 6, wherein the polymerizable site such that a reaction is accelerated by a Lewis acid is a cycloalkyl group, an epoxy group, an oxetane group, a vinyl group, an isocyanate group, an alkoxysilyl group, a hydrosilyl group, or a transition metal alkoxide structure.

9. The non-aqueous liquid electrolyte for a secondary battery according to claim 1, comprising 5.0×10⁻¹ mol/L to 1.0×10⁻² mol/L of the polymerizable monomer.

10. The non-aqueous liquid electrolyte for a secondary battery according to claim 1, comprising 5.0×10⁻² mol/L to 1.0×10⁻⁴ mol/L of the polymerization initiator.

11. A secondary battery, comprising the non-aqueous liquid electrolyte for a swcondary battery according to claim 1.

12. A kit of a non-aqueous liquid electrolyte for a secondary battery, comprising a mixture of a first agent and a second agent,
wherein the first agent comprises an electrolyte, the second agent comprises a polymerizable monomer, and a polymerization initiator comprising a compound having an element of Group XIII of the Periodic Table as a central element thereof and being capable of producing a radical and a Lewis acid in the liquid is contained in the first agent, the second agent and/or another third agent.
